(19) United States
(12) Patent Application Publication
(10) Pub. No.: US 2026/0147333 A1
(43) Pub. Date: May 28, 2026

(54) Systems And Methods For Facilitating Process Improvement

(71) Applicant: James Arthur Byron, Ponte Vedra, FL (US)

(72) Inventor: James Arthur Byron, Ponte Vedra, FL (US)

(21) Appl. No.: 19/400,954

(22) Filed: Nov. 25, 2025

Related U.S. Application Data
(60) Provisional application No. 63/724,855, filed on Nov. 25, 2024.

(51) Int. Cl. G05B 19/418

(52) U.S. Cl. CPC G05B 19/41865; G05B 2219/32027

(57) ABSTRACT

The present disclosure provides generally for systems and methods for facilitating process improvement. According to the present disclosure, a process improvement system may comprise at least one controller, one or more system components, and one or more data collectors. In some aspects, the controller may comprise at least one storage medium and at least one processing device, wherein the storage medium may comprise one or more coded instructions or algorithms that may be accessed and executed by the processing device to enable the processing device to receive data from the data collectors, perform one or more analytical functions on the data to determine whether the data indicates the occurrence of at least one likely issue, identify one or more remedial measures to prevent the issue(s), and implement the remedial measure(s). In some implementations, this may maximize the efficiency or effectiveness of the process improvement system by minimizing potential issues.

### CROSS-REFERENCE TO RELATED APPLICATION

This application claims priority to and the full benefit of U.S. Provisional Patent Application Ser. No. 63/724,855 (filed Nov. 25, 2024, and titled “SYSTEMS AND METHODS FOR FACILITATING PROCESS IMPROVEMENT”), the entire contents of which are incorporated in this application by reference.

### BACKGROUND

In existing industrial processes, such as those found in commercial food or poultry processing, maintaining specific operational parameters is critical for ensuring product quality, safety, and operational efficiency. Traditionally, monitoring these parameters relies on manual intervention. For example, a human operator may be required to periodically collect a sample from a process, such as fluid from a chiller tank or dip tank. This sample is then tested manually, using tools like chemical titration kits, pH test strips, or handheld thermometers, to determine if parameters like chemical concentration, pH, or temperature are within an acceptable range. If a deviation is found, the operator then manually implements a correction, such as by activating a chemical pump, opening a valve, or adjusting a temperature setpoint.

This reliance on manual, periodic monitoring presents significant problems. A primary issue is latency. A process parameter may drift out of its acceptable range shortly after a manual check is performed, leaving the process in a non-compliant or inefficient state for a substantial period (e.g., until the next scheduled check). During this time, the system may be producing non-compliant products (e.g., insufficiently sanitized poultry), wasting resources (e.g., excessive water or energy use), or operating inefficiently. Furthermore, the subsequent manual correction is often imprecise. An operator, upon identifying a deviation, may implement a remedial measure, such as manually activating a chemical pump, based on estimation or a standardized, non-specific protocol. This can easily lead to over-correction, wasting costly chemicals and potentially damaging product, or under-correction, failing to adequately resolve the issue and requiring further manual intervention.

Another significant deficiency in traditional methods is the failure to leverage data for predictive or proactive control. Manual, intermittent readings provide a poor, low-resolution snapshot of the process. This data is often insufficient for identifying subtle trends or complex relationships between different process variables (e.g., how a change in production line speed correlates with a decrease in peracetic acid concentration). Without this comprehensive, real-time data and analytical capability, these systems are fundamentally reactive. They cannot predict a potential problem before it occurs and cannot proactively implement adjustments to optimize efficiency or quality. The systems are merely corrected after a failure has already been detected, leading to increased costs, inconsistent product quality, and potential for regulatory non-compliance. Therefore, a need exists for systems and methods that can autonomously monitor a process in real-time, analyze complex data to predict and identify potential issues or optimization opportunities, and implement precise adjustments without the latency and imprecision of manual intervention.

### SUMMARY OF THE DISCLOSURE

The present disclosure provides systems and methods for facilitating process improvement. In some aspects, this improvement may relate to proactively optimizing a process to enhance efficiency, maximize yield, or improve product quality by implementing one or more process adjustments. In other aspects, the improvement may relate to identifying and preventing potential problems or issues by implementing one or more remedial measures.

In some embodiments, a system for facilitating process improvement may include a system component configured to implement at least one process, one or more data collectors communicatively coupled to the system component to generate at least one datum associated with the process, and at least one controller. The controller may include at least one storage medium and at least one processing device configured to execute one or more coded instructions stored thereon.

In a related method for facilitating process improvement, the at least one processing device may receive the at least one datum from the one or more data collectors. The processing device analyzes the at least one datum and determines, based on the analysis, that the datum indicates at least one potential problem associated with the at least one process. In response to determining a potential problem exists, the processing device identifies one or more remedial measures to prevent the potential problem. The processing device then autonomously implements the one or more remedial measures, such as by causing an adjustment to the system component.

The system component may be part of an industrial fluid system, such as, for example, a poultry processing chiller system. The adjustment to the system component may include instructing a chemical control system to disperse a chemical. The one or more data collectors may include various sensors, such as a temperature sensor, a pH sensor, a peracetic acid sensor, or an imaging device. The analysis may be performed using an artificial intelligence infrastructure. In some implementations, data may be received from both a local data collector and an external data feed (e.g., via a server), with the analysis fusing the data from both sources. The analysis may also include comparing the datum to predefined setpoints or historical data. The determination of a potential problem may also be based, at least in part, on a user-defined parameter received from a remote computing device.

In another specific embodiment, a system for automated microbial control in a poultry processing chiller is provided. The system may include a poultry processing chiller component, a pH sensor, and an imaging device. The controller for this system may include a trained artificial intelligence model. The controller is configured to receive a pH datum and an imaging datum and, using the AI model, generate a predicted microbial load value. This predicted value is then compared to a predetermined microbial safety threshold.

If the predicted value exceeds the threshold, the controller autonomously implements a remedial measure, such as instructing a chemical control system to dispense a peracetic acid solution. This trained artificial intelligence model may be, for example, a convolutional neural network (CNN) trained on a reference dataset of chiller images and known microbial counts to identify visual patterns, such as those indicative of biofilm formation, from the imaging datum. The model may also use data from an external feed, such as environmental temperature data, to generate its prediction. The controller may be configured to continue to dispense the solution until a subsequent datum, such as a new pH datum, indicates the process is back within the safety threshold.

A number of embodiments of the present disclosure will be described. While this specification contains many specific implementation details, these should not be construed as limitations on the scope of any disclosures or of what may be claimed, but rather as descriptions of features specific to particular embodiments of the present disclosure. It is understood to those skilled in the art that variations, modifications, and alterations may be apparent. It will be understood that various modifications may be made without departing from the spirit and scope of the disclosure.

### BRIEF DESCRIPTION OF THE DRAWINGS

The accompanying drawings that are incorporated in and constitute a part of this specification illustrate several embodiments of the disclosure and, together with the description, serve to explain the principles of the disclosure:

FIG. 1 illustrates an exemplary process improvement system, according to some embodiments of the present disclosure.

FIG. 2A illustrates exemplary data obtained from one or more data collectors within a process improvement system, according to some embodiments of the present disclosure.

FIG. 2B illustrates exemplary data obtained from one or more data collectors within a process improvement system, according to some embodiments of the present disclosure.

FIG. 3 illustrates an exemplary application of a process improvement system, according to some embodiments of the present disclosure.

FIG. 4 illustrates an exemplary application of a process improvement system, according to some embodiments of the present disclosure.

FIG. 5 illustrates an exemplary process for facilitating user interaction with a process improvement system, according to some embodiments of the present disclosure.

FIG. 6 illustrates exemplary method steps for a process improvement process, according to some embodiments of the present disclosure.

FIG. 7 illustrates an exemplary computing system that may be used to implement computing functionality for one or more aspects of a process improvement system, according to some embodiments of the present disclosure.

The Figures are not necessarily drawn to scale, as their dimensions can be varied considerably without departing from the scope of the present disclosure.

### DETAILED DESCRIPTION

The present disclosure provides generally for systems and methods for facilitating process improvement. According to the present disclosure, a process improvement system may comprise one or more data collectors communicatively coupled to or integrated with one or more system components, wherein the system component(s) may be configured to implement at least one process. In some aspects, the process improvement system may comprise one or more coded instructions or algorithms that may be at least temporarily stored within at least one storage medium, wherein the coded instructions or algorithms may be accessed and executed by at least one processing device. In some implementations, the storage medium and the processing device may be configured within at least one controller, at least one server, or both. In some embodiments, the controller may be integrated with or communicatively coupled to one or more of the system components and/or one or more of the data collectors. In some implementations, the controller may be communicatively coupled to the server(s) via at least one network connection.

In some aspects, the coded instructions or algorithms of the process improvement system of the present disclosure may be configured to improve at least a portion of one or more system processes or subprocesses facilitated by one or more system components or one or more groupings of system components. In some implementations, the coded instructions or algorithms may, when executed by the processing device, cause the processing device to analyze at least one datum pertaining to at least a portion of the system component(s), wherein the data may be received via the data collector(s). In some embodiments, the coded instructions or algorithms may be configured to enable the processing device to determine that one or more aspects of the data may indicate at least one current or potential problem or issue, identify one or more changes, adjustments, alterations, or similar remedial measures to one or more processes or subprocesses performed by the system component(s) to minimize or avoid such problem(s) or issue(s), and implement the identified remedial measure(s). In some implementations, routine monitoring of the system component(s) may enable the processing device to autonomously implement one or more remedial measures in substantially real time.

Beyond the identification and implementation of remedial measures to address specific problems or issues, the coded instructions or algorithms of the process improvement system may be further configured to facilitate proactive process optimization. In such embodiments, the processing device may analyze the received data, (perhaps in combination with historical data or predefined operational goals), to identify one or more process adjustments configured to enhance overall system performance. For example, a process adjustment may be identified and implemented to improve operational efficiency, such as by reducing the consumption of resources (e.g., energy, water, or chemical reagents), maximizing process throughput or product yield, enhancing the quality or consistency of an output (such as the articles 330), or minimizing the generation of waste.

In the following sections, detailed descriptions of examples and methods of the disclosure will be given. The descriptions of both preferred and alternative examples, though thorough, are exemplary only, and it is understood to those skilled in the art that variations, modifications, and alterations may be apparent. It is therefore to be understood that the examples do not limit the broadness of the aspects of the underlying disclosure as defined by the claims.

### GLOSSARY

Industrial Fluid System (“IFS”): as used herein refers to an industrial system that is at least partially dependent on fluid. In some embodiments, an IFS may comprise a water chiller system or dip tank, such as used in poultry processing, meat processing, or commercial food preparation, as non-limiting examples. In some implementations, an IFS may comprise a rinsing or cleaning system, such as for cleaning produce. In some aspects, an IFS may comprise a conveyor system for delicate items, wherein fluid may limit risk of damage, such as for easily bruised produce. In some embodiments, an IFS may comprise a petroleum system. In some implementations, an IFS may comprise at least one auto-titrating apparatus. In some aspects, an IFS may comprise at least one drip system.
Process: as used herein refers to any method, procedure, sequence, actions, or steps that may facilitate completion of at least one objective or production of at least one output. By way of example and not limitation, a process may comprise the preparation of one or more foodstuffs for sale, distribution, or consumption.
Data collector: as used herein refers to any device, apparatus, or mechanism that may generate at least one datum during operation or performance or that may be configured to gather, collect, receive, or sense at least one datum from one or more data sources. By way of example and not limitation, a data collector may comprise an auto-titrating apparatus that generates data as it functions or a temperature sensor configured to measure the temperature of a fluid, as non-limiting examples.
Molecule: as used herein refers to any element, aspect, quantity, substance, compound, particle, or level that may be measured, monitored, recorded, or tracked by a process improvement system. By way of example and not limitation, a molecule may comprise one or more of: a conductivity level, a temperature, a quantity or concentration of one or more solids, a turbidity, a quantity or concentration of one or more salts, a color, a pH level, a peracetic acid (“PAA”) level or concentration, an acetic acid level or concentration, an oxygen level or concentration, an ozone level or concentration, a hydrogen peroxide level or concentration, a level or concentration of one or more peroxides, a level or concentration of one or more chlorites, a chlorine dioxide level or concentration, a chlorine level or concentration, a level or concentration of one or more chlorides, a level or concentration of one or more chlorine species, a bromine level or concentration, a level or concentration of one or more bromides, a level or concentration of one or more bromine species, a sulfur level or concentration, a level or concentration of one or more sulfites, a level or concentration of one or more sulfur-containing molecules, a level or concentration of one or more quaternary ammonium chlorites, a level or concentration of one or more chlorine compounds, a level or concentration of one or more chlorite compounds, a level or concentration of cetylpyridinium chloride (“CPC”), a causticity, a level or concentration of lactic acid, or an acidity, as non-limiting examples.

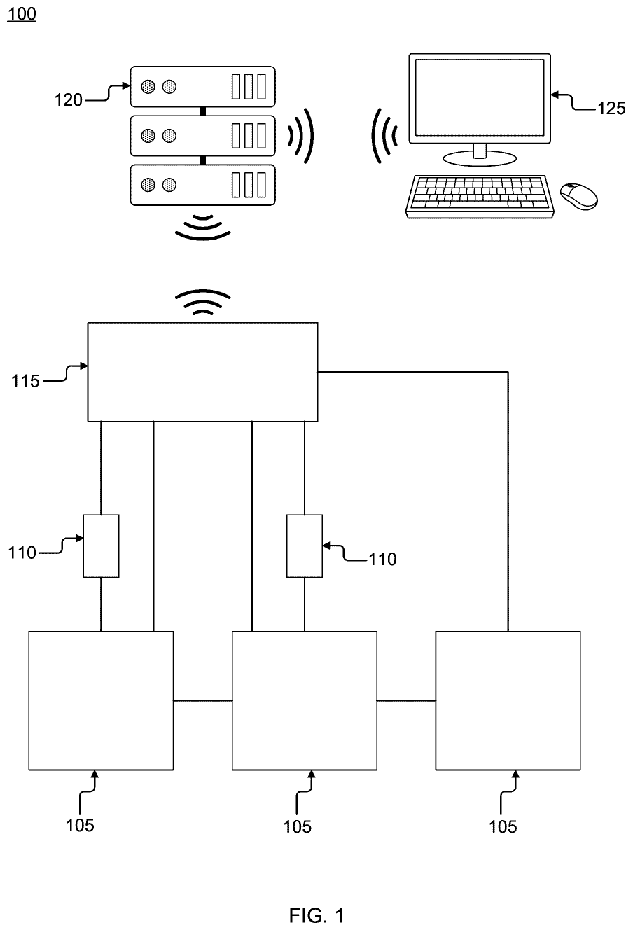

Referring now to FIG. 1, an exemplary process improvement system 100, according to some embodiments of the present disclosure, is illustrated. In some embodiments, the process improvement system 100 may comprise one or more system components 105. In some implementations, the system component(s) 105 may be configured such that the functioning, operation, or performance of the system component(s) 105 may facilitate execution or implementation of at least one process or subprocess. In some non-limiting exemplary implementations, the process improvement system 100 may comprise a plurality of groupings or sets of system components 105, wherein each grouping or set may comprise one or more system components 105. In some implementations, each grouping or set of system component(s) 105 may be configured to execute, perform, or implement a subprocess, wherein the combination of a plurality of subprocesses may facilitate performance, execution, or implementation of an overall process. In some embodiments, two or more system components 105 or two or more groupings or sets of system components 105 may be communicatively, electrically, physically, or mechanically coupled or connected, either directly or indirectly.

In some aspects, the process improvement system 100 may comprise one or more data collectors 110. In some implementations, each data collector 110 may be configured to gather, collect, sense, or detect at least one datum pertaining to or associated with the performance, functioning, or operation of one or more portions of the process improvement system 100. In some embodiments, one or more data collectors 110 may be configured to gather, collect, sense, or detect at least one datum pertaining to or associated with the performance, functioning, or operation of one or more system components 105 and/or one or more groupings or sets of system components 105. In some non-limiting exemplary implementations, one or more data collectors 110 may be configured as sensing or detecting devices communicatively coupled to or integrated with one or more portions of the process improvement system 100, or one or more of the system components 105 may comprise data collectors 110, as non-limiting examples.

In some embodiments, the process improvement system 100 may comprise at least one controller 115. In some aspects, the controller 115 may comprise at least one storage medium and at least one processing device. In some implementations, the controller 115 may be configured to regulate, control, monitor, or otherwise direct the performance, functioning, or operation of one or more portions of the process improvement system 100, including one or more of the system components 105 and/or one or more groupings or sets of system components 105. In some implementations, the storage medium may comprise one or more coded instructions or algorithms that may be accessed and executed by the processing device to cause or enable the processing device to perform one or more operations, functions, or tasks. By way of example and not limitation, the coded instructions or algorithms may enable the processing device to receive at least one datum from one or more of the data collectors 110, perform one or more analytical functions or operations on the received data, determine whether one or more aspects of the data could be improved or whether one or more aspects of the data may indicate a current or potential problem or issue, identify one or more remedial measures for improving the data or avoiding or minimizing the problem or issue, and implement the remedial measure(s), as non-limiting examples.

In some aspects, the process improvement system 100 may comprise one or more servers 120, wherein the servers 120 may be communicatively coupled to the controller 115 by at least one network connection, such as, for example and not limitation, a connection to the global, public Internet, a local area network (“LAN”), a cellular network, or a radio network, as non-limiting examples. In some implementations, at least one of the servers 120 may comprise at least one storage medium that comprises at least a portion of the coded instructions or algorithms that direct or enable the performance of the processing device within the controller 115, wherein the processing device may be configured to access the coded instructions or algorithms within the server(s) 120 via the established network connection. In some embodiments, the controller 115 may be able to download and store the coded instructions or algorithms from the server(s) 120 via the network connection.

In some implementations, the process improvement system 100 may comprise at least one computing device 125. In some aspects, the computing device 125 may comprise a user computing device 125, such as, for example and not limitation, a laptop computer, a desktop computer, a tablet, a smartphone, a gaming console, or a smart watch, as non-limiting examples. In some embodiments, the computing device 125 may comprise at least one storage medium that comprises one or more coded instructions or algorithms, such as, for example and not limitation, at least one software application, that may be executed by at least one processor of the computing device 125 such that the computing device 125 may facilitate user control of and/or remote user access to one or more portions of the process improvement system 100, such as, for example and not limitation, the controller 115, via at least one network connection. In some aspects, the software application or other coded instructions or algorithms may be downloaded or otherwise accessed by the computing device 125 from one or more servers 120 via at least one network connection. In some implementations, at least one input device may be integrated with or communicatively coupled to the computing device 125, such as, for example and not limitation of, a keyboard, a keypad, a pointing device (e.g., a mouse), a touchscreen, a microphone, a motion sensor, a camera, a scanning device, or an accelerometer, wherein a user may use the input device to input or enter one or more commands, instructions, or parameters that may control, adjust, modify, or alter the functioning, performance, or operation of one or more portions of the process improvement system 100, such as, for example and not limitation, one or more of the system components 105.

In some non-limiting exemplary embodiments, the process improvement system 100 may comprise at least one artificial intelligence infrastructure and/or one or more machine learning algorithms used to train the artificial intelligence infrastructure. By way of example and not limitation, the artificial intelligence infrastructure may comprise one or more of: a neural network, a deep neural network, or a support vector machine, as non-limiting examples. In some implementations, the artificial intelligence infrastructure may be configured to identify and/or implement one or more remedial measures for one or more portions of the process improvement system 100, such as one or more of the system components 105 or one or more groupings or sets of system components 105 in an at least partially autonomous manner.

In some embodiments, the data collector 110 may comprise a wide variety of data sources beyond physical sensors. The data collector 110 may comprise one or more imaging devices, such as a machine vision camera, a thermal imager, or a hyperspectral camera. These imaging devices may be configured to capture visual data associated with the articles 330 (e.g., their size, shape, color, or the presence of defects) or associated with a system component 105 (e.g., monitoring a spray nozzle pattern for consistency). In some implementations, the data analyzed by the controller 115 may originate from an external data feed received via the one or more servers 120, such as weather forecasts, utility energy pricing, or raw material cost data. Additionally, data may be collected from a user via the computing device 125, such as new batch parameters or high-level operational goals (e.g., instructions to prioritize process throughput versus minimizing resource consumption).

In some embodiments, wherein the data collector 110 is an imaging device, the received data may comprise a digital image or video stream. The processing device of the controller 115 may be configured with specific machine vision algorithms (as part of the coded instructions) to analyze this image data. For example, the controller may analyze images of articles 330 to detect physical contaminants or discolorations. Upon such a detection, the controller may identify this as a “problem” or “issue” and implement a process adjustment, such as activating a secondary cleaning spray (a system component 105) or signaling a robotic sorter to remove the specific article 330 from the production line.

In some embodiments, the processing device may be configured to perform its analysis (at 615) by fusing data from multiple types of data collectors. For example, the controller 115 may receive temperature data from a sensor in a chiller (a local data collector 110) and, concurrently, receive a real-time energy pricing feed from a server 120 (an external data source). The processing device may then execute an optimization algorithm to determine an optimal chilling setpoint that balances the required product temperature (from sensor data) against the financial cost (from external data), thereby minimizing operational expenditures as part of a process adjustment.

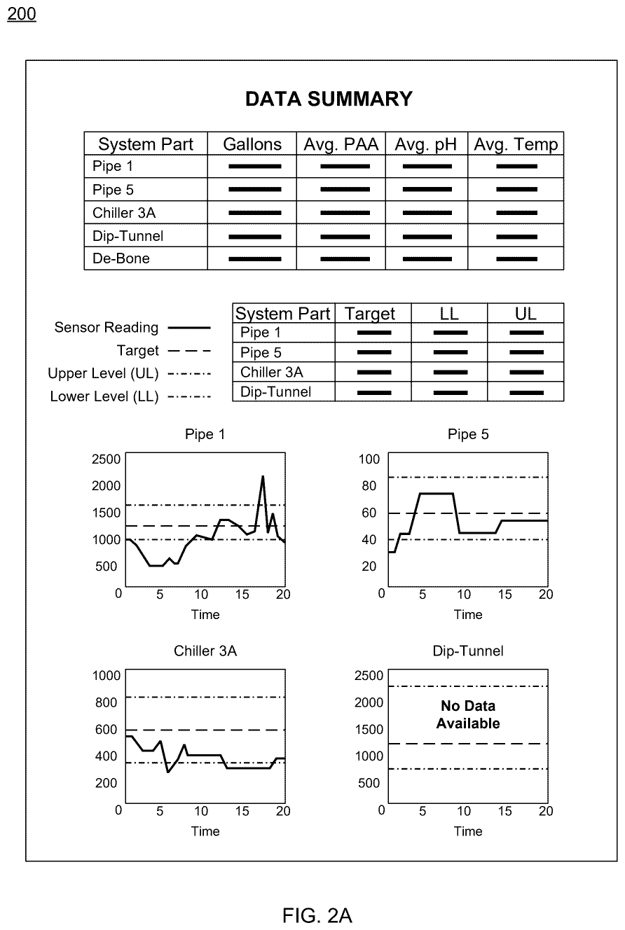

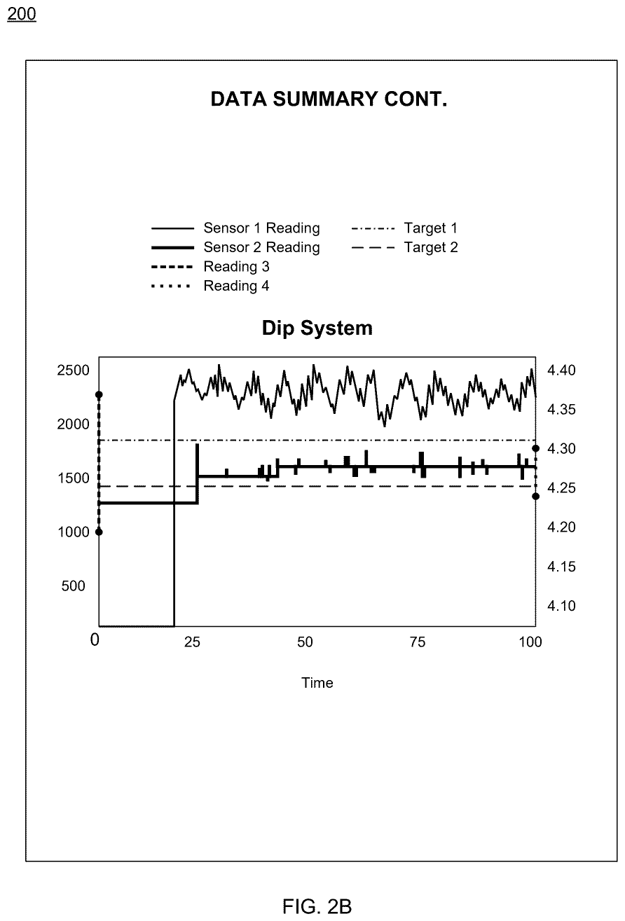

Referring now to FIGS. 2A and 2B, exemplary data 200 obtained from one or more data collectors within a process improvement system, according to some embodiments of the present disclosure, are illustrated. In some aspects, the process improvement system may comprise one or more coded instructions or algorithms configured to receive one or more portions of the data 200, perform or execute one or more analytical functions or operations on one or more portions of the data 200, determine whether one or more aspects of the data 200 could be improved or may indicate one or more potential problems or issues, identify one or more remedial measures to improve one or more aspects of the data 200 or avoid or minimize one or more problems or issues, and implement one or more of the identified remedial measures, as non-limiting examples. In some non-limiting exemplary implementations, at least a portion of the data 200 may be received and analyzed on a continuous or routine basis such that one or more remedial measures may be identified and implemented in substantially real time in response to a determination that such remedial measure(a) are needed or required. In some aspects, one or more remedial measures may at least partially comprise adjusting or altering the performance, functioning, or operation of one or more system components and/or one or more groupings or sets of system components within the process improvement system, as non-limiting examples.

In some implementations, at least a portion of the data 200 may pertain to or may otherwise be directly or indirectly associated with the performance, execution, or implementation of one or more processes or subprocesses facilitated by one or more system components and/or groupings or sets of system components within the process improvement system. In some non-limiting exemplary embodiments, the process improvement system may at least partially comprise an industrial fluid system configured to prepare or process one or more foodstuffs for distribution, sale, and/or consumption, as non-limiting examples. In some aspects, the data 200 may comprise one or more operational or functional measurements or parameters of the industrial fluid system.

As a non-limiting illustrative example, a process improvement system may comprise an industrial fluid system configured to prepare or process poultry for mass distribution and eventual human consumption. In some aspects, the industrial fluid system may comprise a plurality of system components, wherein one or more of the system components may require water and/or chemicals during operation or functioning, and one or more system components may be configured to facilitate and/or monitor the addition of such water and/or chemicals as the industrial fluid system functions. In some embodiments, one or more processes facilitated by the industrial fluid system may be executed most efficiently or most effectively when one or more aspects of the industrial fluid system are at or near a target amount, quantity, range, or value, and/or when one or more aspects of the industrial fluid system maintain a substantially constant or consistent value, rate, or level. By way of example and not limitation, a chemical solution within one or more portions of the industrial fluid system may be most effective when the solution comprises a temperature, pH, and/or peracetic acid (“PAA”) level at or near a targeted value. In some implementations, one or more controllers integrated with or communicatively coupled to the industrial fluid system may comprise one or more coded instructions or algorithms configured to receive temperature, pH, PAA, and/or similar data 200 from one or more data collectors integrated with or communicatively coupled to one or more portions or components of the industrial fluid system such that upon receiving a measurement or reading that deviates from the targeted value by a predetermined threshold amount, the controller(s) may adjust the rate at which water, chemical(s), or other fluids are added to the relevant portion(s) or component(s) of the industrial fluid system to bring the value(s) back to the targeted level(s).

In some non-limiting exemplary embodiments, the controller(s) of a process improvement system, such as, for example and not limitation, an industrial fluid system, may be configured to receive data 200 from one or more data collectors on a continuous, routine, or scheduled basis. By way of example and not limitation, the controller(s) may be configured to receive data from the data collector(s) every 30 seconds. In some aspects, by regularly receiving updated data, the controller(s) may be able to quickly determine whether one or more remedial measures may need to be implemented for the process improvement system, identify such remedial measure(s), and implement the remedial measure(s) so that the relevant affected portion(s) or component(s) of the process improvement system may be brought back to one or more targeted values or ranges in a timely manner or may be prevented from deviating from the targeted values or ranges in the first place. In some implementations, any necessary remedial measure(s) identified by the controller(s) may be implemented in a nearly instantaneous fashion upon receiving data 200 that indicates that the remedial measure(s) are needed or required.

In some aspects, one or more controllers of a process improvement system may be configured with one or more coded instructions or algorithms that enable the controller(s) to preemptively identify and/or implement one or more remedial measures in response to data received from one or more data collectors that may indicate a high likelihood of an upcoming need for such remedial measure(s). In some implementations, this may allow the process improvement system to prevent or minimize any deviations to any targeted values, levels, or ranges, thereby allowing one or more processes facilitated by the process improvement system to be implemented or executed with increased efficiency or effectiveness in response to one or more sensed, detected, or identified process variations.

By way of example and not limitation, a process improvement system may comprise an industrial fluid system configured to prepare or process poultry for human consumption. In some implementations, a poultry preparation process may comprise one or more variables that may be sensed, detected, or identified by the process improvement system such that the process improvement system may identify, initiate, and/or implement one or more remedial measures in substantially real time upon sensing, detecting, or identifying one or more variations. In some non-limiting exemplary embodiments, a poultry processing variation may comprise a variation in one or more of: a bird size, a physical condition of a carcass, a processing strategy decision, a processing technique decision, a carcass surface area, a bird fat content, a bird disease or infection status, a bird bacteria level, plant or equipment design, or plant operation parameters, as non-limiting examples.

As a non-limiting illustrative example, a process improvement system may comprise an industrial fluid system configured to prepare or process poultry for human consumption. In some aspects, an amount of chemical solution needed to process the poultry may be at least partially dependent on the production line speed of the industrial fluid system, wherein more of the chemical solution may be needed as the production line speed increases as more birds are being processed. In some implementations, upon receiving data that indicates an increase in the production line speed, the controller(s) of the industrial fluid system may initiate an increase in the amount of the chemical solution being added to the industrial fluid system before a deficiency in the chemical solution is detected, thereby preventing the deficiency from occurring. In some embodiments, the controller(s) may be configured to calculate or determine how great the increase of the chemical solution needs to be based on how much the production line speed has increased, thereby helping to ensure the appropriate amount of chemical solution is added.

In some implementations, a process improvement system may comprise at least one artificial intelligence infrastructure that may be at least partially trained using one or more machine learning algorithms. In some embodiments, this may allow the controller(s) of the process improvement system to become increasingly better at determining when one or more remedial measures may be needed by the process improvement system so that the remedial measure(s) may be implemented with minimal or no substantial latency, thereby preventing or minimizing any deviations from any targeted values, levels, or ranges within the process improvement system or any component(s) or set(s) of components therein or associated therewith.

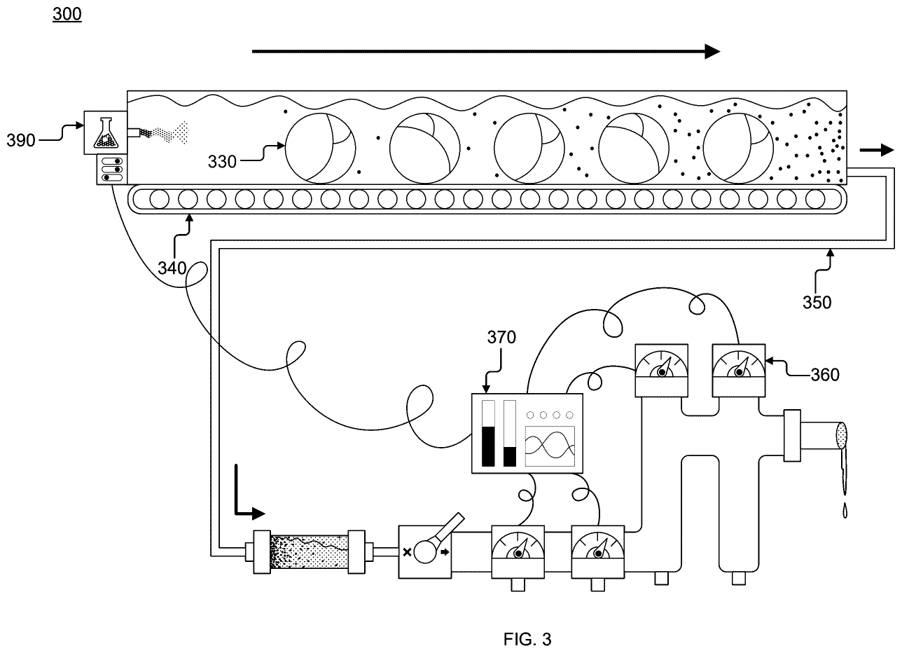

Referring now to FIG. 3, an exemplary application of a process improvement system 300, according to some embodiments of the present disclosure, is illustrated. In some aspects, the process improvement system 300 may be configured to implement, execute, or facilitate at least one process on one or more articles 330, wherein each article 330 may comprise an object, animal, foodstuff, or similar item or element, as non-limiting examples. In some implementations, a plurality of articles 330 may be transported throughout one or more portions of the process improvement system 300 via at least one production line. In some embodiments, the production line may comprise at least one conveyance mechanism, either currently existing or developed in the future, such as, for example and not limitation, at least one conveyor belt 340, at least one conveying screw, and/at least one conveying dragline, pipeline, tank(s), vessel, containment, and enclosure, as non-limiting examples.

In some non-limiting exemplary implementations, the process improvement system 300 may at least partially comprise at least one industrial fluid system, such as may be used for produce processing or poultry cleaning and chilling, as non-limiting examples. In some implementations, at least a portion of one or more fluids used within one or more portions of the industrial fluid system may be directed through at least one sampling pipe 350. In some aspects, at least a portion of the process improvement system 300 may be configured to regulate processing temperature for one or more articles 330 that may comprise sauces, poultry, agricultural produce, seafood, chemicals, or pharmaceutical drugs, as non-limiting examples. In some embodiments, the process improvement system 300 may comprise at least one chiller or similar device or apparatus that may be configured to cool or heat one or more articles 330 based at least partially on one or more predefined parameters. In some aspects, the process improvement system 300 may comprise at least one controller 370 that may be configured to receive and analyze data generated from one or more components of the industrial fluid system. In some embodiments, the controller 370 may be configured to implement one or more adjustments, alterations, or changes to one or more of the components of the industrial fluid system to produce an optimal outcome based on the analysis.

In some embodiments, the sampling pipe 350 may be configured draw a limited stream of fluid from the process improvement system 300, such as may be necessary to adequately assess one or more quality aspects of the fluid. In some implementations, one or more chemicals or solutions may be added to the process improvement system 300 in an at least partially autonomous manner based on one or more instructions received from at least one controller 370 to maintain or achieve one or more predetermined targeted ranges, values, or levels within the process improvement system 300. By way of example and not limitation, one or more caustic, acidic, or other materials or substances with useful or desirable properties may be added to maintain a predefined pH setpoint of at least a portion of one or more fluids within the process improvement system 300, which may allow for the maintenance or achievement of a peracetic acid (“PAA”), acidified sodium chlorite (“ASC”), or other chemical or substance level, range, or setpoint that may be preferable or required by the process improvement system 300 to operate or function to produce sufficient, satisfactory, or desirable outputs, such as one or more prepared or processed articles 330, as a non-limiting examples.

In some embodiments, the process improvement system 300 may comprise one or more data collectors in the form of one or more sensing devices 360. In some implementations, the sensing device(s) 360 may be configured to transmit data to the controller 370 of the process improvement system 300 that may notify the controller 370 when one or more undesirable, harmful, or problematic features, characteristics, measurements, or occurrences are detected within one or more portions of the process improvement system 300, such as an amount of one or more particulates or unwanted chemistry, as non-limiting examples. In some embodiments, the sensing device(s) 360 may be configured such that at least a portion of the data transmitted therefrom may indicate to the controller 370 where the particulate(s), unwanted chemistry, or other issue or concern may be located within the process improvement system 300, which may enable the controller 370 to implement, initiate, determine, and/or recommend one or more remedial measures to address or resolve the issue. By way of example and not limitation, a particulate may include one or more of: an amount of blood, fat, excess product, soluble material, or solids of any kind, whether dissolved or not. In some aspects, the sensing device(s) 360 may be configured to indicate when one or more portions of the process improvement system 300 may be out of compliance or may be malfunctioning, which may occur, for example and not limitation, if an amount of one or more particulates adheres to at least a portion of a sensing device 360 or one or more of: a peracetic acid, an acidified sodium chlorite, or another chemical or substance level deviates outside of an acceptable, preferred, or tolerable range.

In some implementations, at least a portion of the data received from the sensing device(s) 360 may enable the controller 370 of the process improvement system 300 to continuously monitor fluid flow within one or more portions of the process improvement system 300, such as, for example and not limitation, one or more portions of an industrial fluid system. In some aspects, the controller 370 may be configured to control all or one or more portions of the process improvement system 300. In some embodiments, the controller 370 may be configured to control the flow of water or fluid within one or more portions of the process improvement system 300, such as the conveyance mechanism, such as, for example and not limitation, the conveyor belt 340; the sensing device(s) 360; or one or more other data collectors or system components, as non-limiting examples. In some implementations, the controller 370 may be configured to turn the entire process improvement system 300 on or off or reset the process improvement system 300 if it malfunctions. In some embodiments, the controller 370 may be configured to be programmed by a user to initiate, instigate, or facilitate one or more functions, operations, or actions of the process improvement system 300. By way of example and not limitation, a user may program the controller 370 to automatically execute a cleaning treatment process within the process improvement system 300 at one or more predetermined times, such as a frequency per day, shift, week, and/or hour, as well as an associated predetermined execution time duration, as non-limiting examples.

In some aspects, the process improvement system 300 may comprise at least one chemical control system 390 that may be configured to facilitate quality control of one or more aspects of one or more fluids within one or more portions of the process improvement system 300. In some implementations, the chemical control system 390 may be configured to transmit one or more notifications to the controller 370 that one or more molecules or other quality aspects of one or more fluids may be out of an acceptable range or may have deviated from an acceptable compliance level, which may cause the controller 370 to instruct the chemical control system 390 to add one or more chemicals, compounds, or substances to the fluid(s) to adjust the chemistry thereof. By way of example and not limitation, the fluid(s) may become tainted or may be too caustic, and the sensing device(s) 360 may transmit data to the controller 370 indicative of the detected condition(s), which may cause the controller 370 to prompt the chemical control system 390 to disperse an amount of one or more chemicals or compounds into one or more relevant or applicable portions of the process improvement system 300 and into the stream of the fluid(s). In some embodiments, the chemical control system 390 may comprise a plurality of different chemicals based on the use, objective, or purpose of the fluid(s) in the process improvement system 300. In some implementations, the chemical control system 390 may be at least temporarily connected to at least one chemical supply system that may be able to supply one or more of a plurality of different chemicals on a continuous, on-demand, or as-needed basis that may be useful to adjust one or more monitored fluid qualities. By way of example and not limitation, chemicals that comprise properties that may facilitate the adjustment of fluid pH may be supplied when pH is monitored.

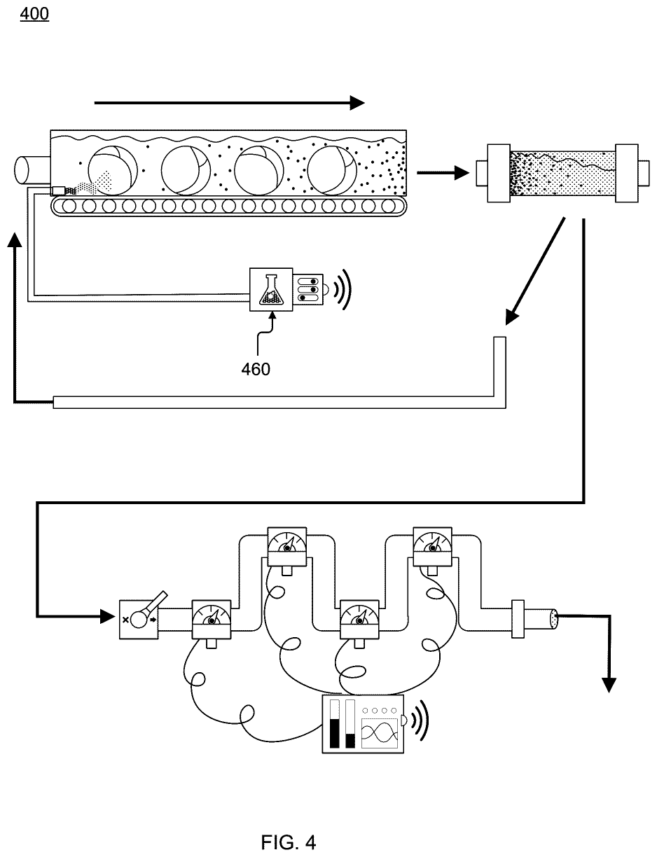

Referring now to FIG. 4, an exemplary application of a process improvement system 400, according to some embodiments of the present disclosure, is illustrated. In some implementations, the process improvement system 400 may comprise at least one sensing or monitoring portion that comprises one or more sensing devices or similar data collectors through which one or more fluids may flow for testing, wherein a small portion of the fluid(s) may be removed to monitor quality or to ensure the fluid(s) have not been contaminated, as non-limiting examples. In some implementations, a small portion of fluid may be removed at one or more of a plurality of locations throughout the process improvement system 400 to enable continuous or routine fluid sampling to occur throughout the process improvement system 400.

In some embodiments, the process improvement system 400 may comprise at least one controller configured to perform one or more analytical functions or operations on data received from the data collector(s). In some implementations, the process improvement system 400 may be configured to operate in an at least partially autonomous manner as directed by the controller as the controller executes one or more stored instructions or algorithms. In some embodiments, the process improvement system 400 may comprise at least one storage medium configured to at least temporarily store at least one datum pertaining to one or more typical or routine fluid cycles and chemical levels within the process improvement system 400, as non-limiting examples of fluid attributes. In some aspects, the controller of the process improvement system 400 may be configured to execute or otherwise utilize one or more machine learning algorithms to automatically adjust one or more fluid attributes or molecules during performance of one or more portions of the process improvement system or to make one or more alterations to the operation or functioning of the process improvement system 400, as non-limiting examples. In some embodiments, the controller of the process improvement system 400 may be configured to receive data that enables the controller to detect when one or more molecules within the process improvement system above or below one or more predefined thresholds and automatically initiate one or more remedial measures to bring the molecule(s) within the threshold tolerance levels. In some implementations, the controller of the process improvement system 400 may be configured to monitor one or more predetermined thresholds continuously during use of the process improvement system 400 and activate one or more automated protocols when the threshold(s) are exceeded.

As a non-limiting illustrative example, the controller of the process improvement system 400 may receive at least one datum from at least one data collector that may indicate that the salinity of one or more fluids within one or more portions of the process improvement system 400 is too high or too low and one or more sensing devices are transmitting measurements or readings that exceed accuracy tolerance thresholds. In some implementations, the controller may be configured to calculate or otherwise determine a required fluid level adjustment to ensure that an amount incoming freshwater is received to lower the salinity levels to satisfy a predefined threshold, and the controller may activate an internal cleaning system to improve the accuracy of the relevant sensing device(s). In some embodiments, the controller may repeatedly initiate the cleaning cycle as needed whenever the readings from the sensing device(s) display inaccuracies exceeding one or more predetermined tolerance ranges. In some aspects, the controller may be configured to autonomously initiate one or more preventative or remedial measures to maintain the accuracy of the readings received from the sensing device(s) by implementing one or more cleaning, rinsing, and/or flushing cycles or actions and/or one or more series of actions on a periodic, routine, or predefined schedule. In some implementations, the controller may be configured to receive data from one or more data collectors that may be indicative of one or more malfunctions within one or more portions of the process improvement system 400. In some aspects, the controller may be configured to autonomously initiate one or more remedial measures to correct the identified errors in a timely manner, such as, for example and not limitation, in substantially real time.

In some embodiments, the process improvement system 400 may comprise at least one chemical control system 460. In some implementations, the chemical control system 460 may be controlled remotely via at least one wireless or wired connection. In some aspects, the chemical control system 460 may be used to control the levels of one or more chemicals or substances within an amount of chiller fluid that may be used within one or more portions of the process improvement system 400. In some embodiments, the controller of the process improvement system 400 may be programmed to activate the chemical control system 460 to disperse chemicals throughout one or more portions of the process improvement system 400 when the controller determines such dispersement is needed.

In some aspects, one or more sensing devices of the process improvement system 400 may be configured to capture data and provide at least a portion of the captured data to the controller such that the controller may initiate the dispersement of one or more chemicals via the chemical control system 460 to stabilize the chiller fluid or other fluid(s) throughout one or more portions of the process improvement system 400. In some implementations, the chemical control system 460 may be filled with one or more of a plurality of different chemicals based on the chiller fluid composition, dips, vats, tanks, containments, process pipes, and vessels, the preference(s) of a user, or the requirements of an associated industrial fluid system, as non-limiting examples. By way of example and not limitation, different industrial fluid systems may require different chemistry levels of fluid, and based on the predefined criteria for an industrial fluid system, the chemical control system 460 may provide relevant adjusting chemicals for dispersement into the system when required or needed.

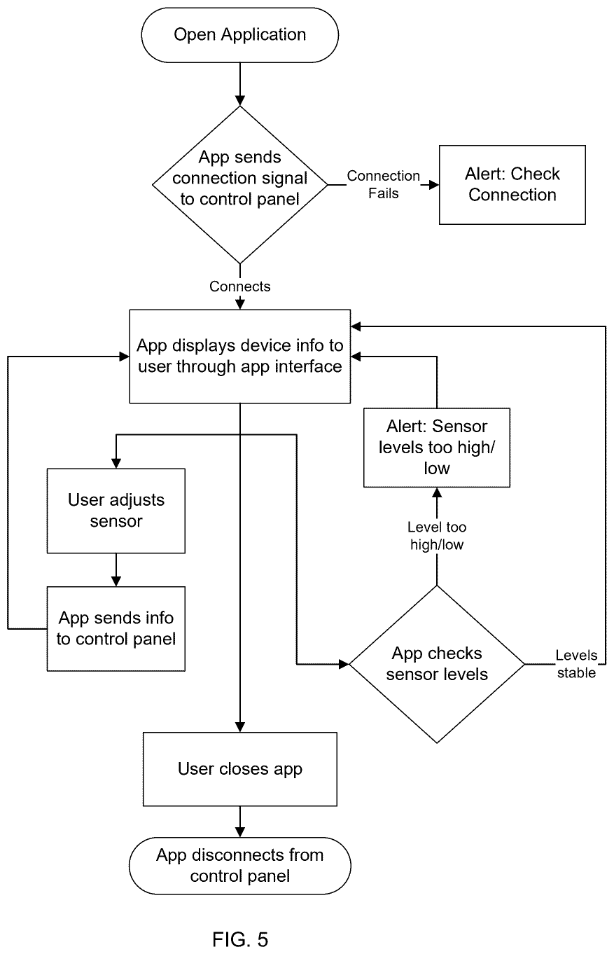

Referring now to FIG. 5, an exemplary process 500 for facilitating user interaction with a process improvement system, according to some embodiments of the present disclosure, is illustrated. In some aspects, process 500 may enable at least one user of a process improvement system to interact with the process improvement system remotely via at least one computing device communicatively coupled to the process improvement system via at least one network connection. In some implementations, process 500 may enable the user to access and interact with at least one controller of the process improvement system via one or more coded instructions or algorithms in the form of, for example and not limitation, at least one software application or program. In some embodiments, the software application may be configured to transmit and/or receive one or more signals to and/or from the controller. In some aspects, the software application may transmit or receive data or instructions to or from one or more data collectors or other system components of the process improvement system.

In some implementations, the transmitted signals may relay information back to the user computing device so that the user may operate or otherwise interact with the process improvement system remotely. In some embodiments, the user may have preset levels or settings for one or more sensing devices, data collectors, system components, molecules, pH levels, chemical levels, or other non-limiting examples within the process improvement system. In some aspects, the software application may be configured to alert the user via the computing device if one or more of the preset levels or settings are too high or too low, or if data is received that indicates that one or more measurements associated with one or more of the preset settings have deviated from a set range or value, as non-limiting examples. In some embodiments, different notifications may be associated with different discrepancies.

In some aspects, the user may have the option to set the software application to instruct the controller of the process improvement system to automatically initiate one or more remedial measures when a discrepancy is detected or when data is received that indicates a discrepancy is likely to occur. In some implementations, the user may be required to be authenticated to override the controller if one or more of the set levels need to be altered, wherein such authentication may be facilitated by the user entering a password, passcode, biometric scan, or similar input, as non-limiting examples. By way of example and not limitation, if the preset levels need to be adjusted, the software application may require the user to enter a passcode before changing the levels. In some embodiments, the application may record data and send the recorded data to at least one external or offline storage medium or system. In some aspects, when a discrepancy occurs the software application may be configured to transmit data indicating such discrepancy for at least temporary storage within the storage medium or system.

In some embodiments, the data collected by the process improvement system may be collected, stored, and analyzed over time using one or more coded instructions or algorithms to identify one or more trends or patterns that may form a correlation between one or more types of collected data and an associated discrepancy, issue, or decrease in efficiency or effectiveness within one or more portions of the process improvement system. In some aspects, this may allow the controller of the process improvement system to immediately implement one or more changes, adjustments, or alterations upon a subsequent detection of similar conditions within the process improvement system indicated by the receipt of the same or a substantially similar data set.

In some non-limiting exemplary implementations, a user may opt to manually adjust one or more levels, values, or ranges within or associated with one or more portions of the process improvement system remotely. In some aspects, such manual adjustments may be transmitted via the software application to the controller to implement the adjustments or alterations within the process improvement system. In some embodiments, the software application may disconnect from the controller when the software application is closed.

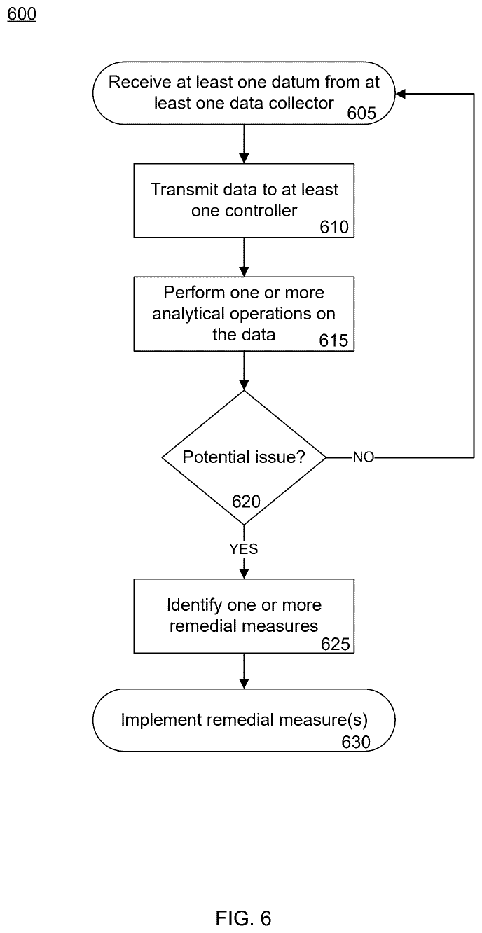

Referring now to FIG. 6, exemplary method steps for a process improvement process 600, according to some embodiments of the present disclosure, are illustrated. In some implementations, process 600 may be at least partially facilitated by a process improvement system.

In some aspects, at 605, at least one datum may be received from at least one data collector of a process improvement system. In some implementations, the data collector may comprise one or more sensing devices and/or one or more components of the process improvement system. By way of example and not limitation, the data collector may comprise one or more of: a flow meter, a temperature sensor, a pressure sensor, a pH sensor, a peracetic acid sensor, a molecule sensor, an amperometric sensor, a diaphragm-covered amperometric sensor, an electrode, a diaphragm-covered electrode, one or more backscatter lighting components or devices, a light reflection sensor, a light absorbance sensor, a light sensor, a glass bulb sensor, an electrical chemical sensing device, a chemical sensing device, or an auto-titration apparatus, as non-limiting examples. In some non-limiting exemplary embodiments, data may be received on a recurring, continuous, or otherwise regular basis. By way of example and not limitation, data may be received every 10 seconds, every 30 seconds, every five minutes, or any desired or required time increment.

In some implementations, at 610, the received data may be transmitted to at least one controller of the process improvement system. In some embodiments, the controller may comprise at least one storage medium and at least one processing device, wherein the storage medium may comprise one or more coded instructions or algorithms that may be accessed and executed by the processing device to enable the processing device to, at 615, perform one or more analytical functions or operations on the received data.

In some aspects, at 620, a determination may be made as to whether the data indicates a current or potential problem, issue, or concern within one or more portions of the process improvement system. In some embodiments, such determination may be at least partially based on at least one analytical comparison between the received data and previously-received data stored within at least one storage medium, wherein at least a portion of the previously-received data may be correlated to or otherwise associated with one or more problems or issues within the process improvement system that may negatively affect the effectiveness, efficiency, or other performance aspect(s) of the process improvement system such that upon receipt of similar data, the controller of the process improvement system may determine that the problem or issue is likely to occur again. In some aspects, a positive determination may cause process 600 to proceed to 625, while a negative determination may cause process 600 to return to 605.

In some implementations, at 625, one or more remedial measures may be identified to prevent or minimize any issues or problems associated with the effectiveness or efficiency of the process improvement system. In some embodiments, the remedial measure(s) may be at least partially identified by performing one or more analytical functions or operations to calculate one or more changes, alterations, or adjustments that may need to be made to the performance, functioning, or operation of one or more system components to prevent or minimize any impending issues or problems. In some implementations, the remedial measures may be at least partially identified by performing at least one comparative analysis on previously-received data to identify one or more similar remedial measures that may have been previously implemented and to evaluate the effectiveness of such remedial measure(s) as part of a feedback loop. In some embodiments, the remedial measures may be at least partially identified by performing at least one comparative analysis against one or more predefined or predetermined setpoints or control ranges to identify one or more changes, alterations, or adjustments that may need to be made to one or more system components to maintain satisfactory system performance and/or to prevent or minimize any impending issues or problems.

In some aspects, at 630, one or more of the identified remedial measures may be implemented. In some implementations, the remedial measure(s) may be implemented in an at least partially autonomous manner by the controller of the process improvement system. In some non-limiting exemplary embodiments, the remedial measure(s) may be implemented in a completely autonomous manner by the controller of the process improvement system. In some implementations, the controller may be configured to prompt one or more of the system components to adjust, change, or alter one or more performance parameters or aspects. In some embodiments, the remedial measure(s) may be implemented in substantially real time upon receiving data that may indicate the need for the remedial measure(s), thereby minimizing or eliminating any latency that may be associated with waiting for a problem or issue to be detected and evaluated before implementing any remedial measures, which may minimize any decrease in efficiency, effectiveness, or performance within the process improvement system.

In some non-limiting exemplary implementations, the process improvement system may comprise at least one artificial intelligence infrastructure configured to use machine learning to analyze data received from the data collectors, determine whether the data is likely to represent at least one current or inevitable problem or issue within the process improvement system, identify one or more remedial measures to prevent or minimize the problem(s) or issue(s), and implement the identified remedial measure(s). In some aspects, the artificial intelligence infrastructure may be configured to continuously improve its analytical capabilities as more data is received, thereby making the implementation of remedial measures faster and more accurate over time, which may even further minimize or prevent any problems or issues within the process improvement system.

As a non-limiting illustrative example, a process improvement system may at least partially comprise at least one industrial fluid system configured to process poultry or similar foodstuffs or articles for eventual human consumption. In some aspects, the industrial fluid system may be configured to use one or more chemical solutions to kill one or more bacteria and/or organisms and/or to achieve or preserve one or more desired or required physical conditions for the article(s) being introduced to at least one production process or procedure. In some implementations, a controller of the process improvement system may be configured with one or more coded instructions or algorithms that enable the controller to regularly receive data from one or more data collectors that may measure the pH, chemical composition, temperature, or other molecules of one or more fluids within one or more portions of the process improvement system, as well as the amperage of one or more system components and a production line speed, as non-limiting examples.

In some embodiments, upon receiving data that indicates that the amperage of one or more of the system components has increased, as well as the production line speed, the controller may determine that more articles are about to be processed by the industrial fluid system, and so the controller may automatically initiate an increase in the amount of chemical solution being added to the industrial fluid system so that the process improvement system may maintain a high amount of effectiveness and efficiency as the output of the system increases. By way of example and not limitation, articles that may be processed by the industrial fluid system may include poultry; lettuce; spinach; pork; beef; fruits; vegetables; proteins; packaged foods such as dressings, sauces, or soups; other foodstuffs; or manufactured products, as non-limiting examples.

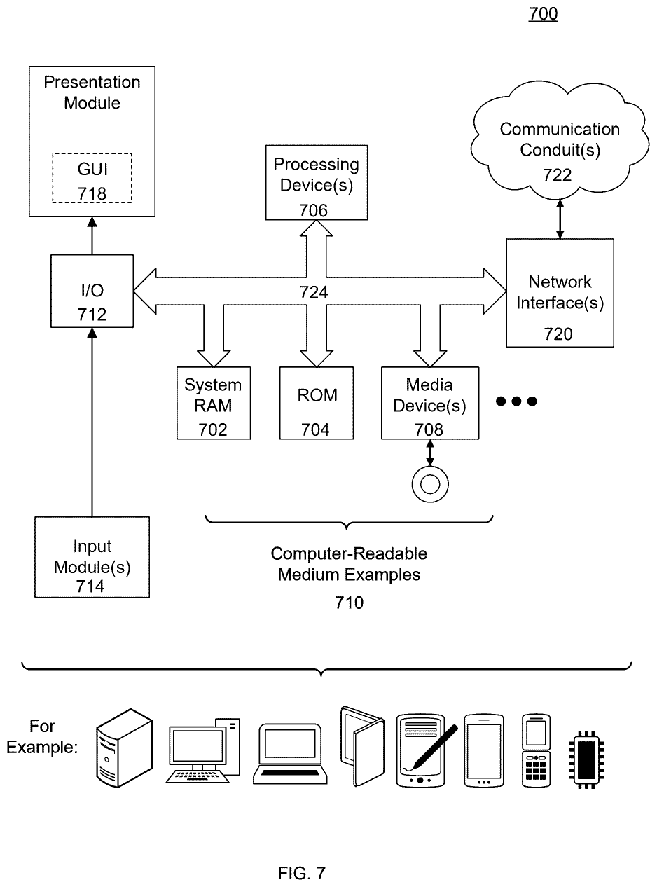

Referring now to FIG. 7, an exemplary computing system that may be used to implement computing functionality 700 for one or more aspects of a process improvement system, according to some embodiments of the present disclosure, is illustrated. In some aspects, computing functionality 700 may comprise volatile and non-volatile memory, such as RAM 702 and ROM 704, as well as one or more processing devices 706 (e.g., one or more central processing units (CPUs), one or more graphical processing units (GPUs), and the like). Computing functionality 700 also optionally comprises various media devices 708, such as a hard disk module, an optical disk module, and so forth. Computing functionality 700 may perform various operations identified above when the processing device(s) 706 execute(s) instructions that are maintained by memory (e.g., RAM 702, ROM 704, and the like).

More generally, instructions and other information may be stored on any computer readable medium 710, including, but not limited to, static memory storage devices, magnetic storage devices, and optical storage devices. The term “computer readable medium” also encompasses plural storage devices. In all cases, computer readable medium 710 represents some form of physical and tangible entity. By way of example and not limitation, computer readable medium 710 may comprise “computer storage media” and “communications media.”

“Computer storage media” comprises volatile and non-volatile, removable and non-removable media implemented in any method or technology for storage of information, such as computer readable instructions, data structures, program modules, or other data. Computer storage media may be, for example, and not limitation, RAM 702, ROM 704, EEPROM, Flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically comprise computer readable instructions, data structures, program modules, or other data in a modulated data signal, such as carrier wave or other transport mechanism. Communication media may also comprise any information delivery media. The term “modulated data signal” means a signal that has one or more of its characteristics set or changed in such a manner as to encode information in the signal. By way of example, and not limitation, communication media comprises wired media such as wired network or direct-wired connection, and wireless media such as acoustic, RF, infrared, and other wireless media. Combinations of any of the above are also included within the scope of computer readable medium.

Computing functionality 700 may also comprise an input/output module 712 for receiving various inputs (via input modules 714), and for providing various outputs (via one or more output modules). One particular output module mechanism may be a presentation module 716 and an associated GUI 718. Computing functionality 700 may also include one or more network interfaces 720 for exchanging data with other devices via one or more communication conduits 722. In some aspects, one or more communication buses 724 communicatively couple the above-described components together.

Communication conduit(s) 722 may be implemented in any manner (e.g., by a local area network, a wide area network (e.g., the Internet), and the like, or any combination thereof). Communication conduit(s) 722 may include any combination of hardwired links, wireless links, routers, gateway functionality, name servers, and the like, governed by any protocol or combination of protocols.

### CONCLUSION

A number of embodiments of the present disclosure have been described. While this specification contains many specific implementation details, these should not be construed as limitations on the scope of any disclosures or of what may be claimed, but rather as descriptions of features specific to particular embodiments of the present disclosure.

Certain features that are described in this specification in the context of separate embodiments can also be implemented in combination or in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described components and systems can generally be integrated together in a single product or packaged into multiple products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

Reference in this specification to “one embodiment,” “an embodiment,” any other phrase mentioning the word “embodiment”, “aspect”, or “implementation” means that a particular feature, structure, or characteristic described in connection with the embodiment is included in at least one embodiment of the disclosure and also means that any particular feature, structure, or characteristic described in connection with one embodiment can be included in any embodiment or can be omitted or excluded from any embodiment. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others and may be omitted from any embodiment. Furthermore, any particular feature, structure, or characteristic described herein may be optional.

Similarly, various requirements are described which may be requirements for some embodiments but not other embodiments. Where appropriate any of the features discussed herein in relation to one aspect or embodiment of the invention may be applied to another aspect or embodiment of the invention. Similarly, where appropriate any of the features discussed herein in relation to one aspect or embodiment of the invention may be optional with respect to and/or omitted from that aspect or embodiment of the invention or any other aspect or embodiment of the invention discussed or disclosed herein.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks: The use of highlighting has no influence on the scope and meaning of a term; the scope and meaning of a term is the same, in the same context, whether or not it is highlighted.

It will be appreciated that the same thing can be said in more than one way. Consequently, alternative language and synonyms may be used for any one or more of the terms discussed herein. No special significance is to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

It will be appreciated that terms such as “front,” “back,” “top,” “bottom,” “side,” “short,” “long,” “up,” “down,” “aft,” “forward,” “inboard,” “outboard” and “below” used herein are merely for ease of description and refer to the orientation of the components as shown in the figures. It should be understood that any orientation of the components described herein is within the scope of the present invention.

In a preferred embodiment of the present invention, functionality is implemented as software executing on a server that is in connection, via a network, with other portions of the system, including databases and external services. The server comprises a computer device capable of receiving input commands, processing data, and outputting the results for the user. Preferably, the server consists of RAM (memory), hard disk, network, central processing unit (CPU). It will be understood and appreciated by those of skill in the art that the server could be replaced with, or augmented by, any number of other computer device types or processing units, including but not limited to a desktop computer, laptop computer, mobile or tablet device, or the like. Similarly, the hard disk could be replaced with any number of computer storage devices, including flash drives, removable media storage devices (CDs, DVDs, etc.), or the like.

The network can consist of any network type, including but not limited to a local area network (LAN), wide area network (WAN), and/or the internet. The server can consist of any computing device or combination thereof, including but not limited to the computing devices described herein, such as a desktop computer, laptop computer, mobile or tablet device, as well as storage devices that may be connected to the network, such as hard drives, flash drives, removable media storage devices, or the like.

The storage devices (e.g., hard disk, another server, a NAS, or other devices known to persons of ordinary skill in the art), are intended to be nonvolatile, computer readable storage media to provide storage of computer-executable instructions, data structures, program modules, and other data for the mobile app, which are executed by CPU/processor (or the corresponding processor of such other components). There may be various components of the present invention that are stored or recorded on a hard disk or other like storage devices described above, which may be accessed and utilized by a web browser, mobile app, the server (over the network), or any of the peripheral devices described herein. One or more of the modules or steps of the present invention also may be stored or recorded on the server, and transmitted over the network, to be accessed and utilized by a web browser, a mobile app, or any other computing device that may be connected to one or more of the web browser, mobile app, the network, and/or the server.

References to a “database” or to “database table” are intended to encompass any system for storing data and any data structures therein, including relational database management systems and any tables therein, non-relational database management systems, document-oriented databases, NoSQL databases, or any other system for storing data.

Software and web or internet implementations of the present invention could be accomplished with standard programming techniques with logic to accomplish the various steps of the present invention described herein. It should also be noted that the terms “component,” “module,” or “step,” as may be used herein, are intended to encompass implementations using one or more lines of software code, macro instructions, hardware implementations, and/or equipment for receiving manual inputs, as will be well understood and appreciated by those of ordinary skill in the art. Such software code, modules, or elements may be implemented with any programming or scripting language such as C, C++, C #, Java, Cobol, assembler, PERL, Python, PHP, or the like, or macros using Excel or other similar or related applications with various algorithms being implemented with any combination of data structures, objects, processes, routines or other programming elements.

What is claimed is:

1. A system for facilitating process improvement, including:
a system component configured to implement at least one process;
one or more data collectors communicatively coupled to the system component, the one or more data collectors configured to generate at least one datum associated with the at least one process;
at least one controller communicatively coupled to the one or more data collectors, the at least one controller including:
at least one storage medium;
at least one processing device; and
one or more coded instructions stored in the at least one storage medium, wherein the one or more coded instructions, when executed by the at least one processing device, cause the at least one processing device to:
receive the at least one datum from the one or more data collectors;
analyze the at least one datum;
determine, based on the analysis, that the at least one datum indicates at least one potential problem associated with the at least one process;
identify, in response to the determination, one or more remedial measures to prevent the at least one potential problem; and
autonomously implement the one or more remedial measures by causing an adjustment to the system component.

2. The system of claim 1, wherein the system component is part of an industrial fluid system.

3. The system of claim 2, wherein the industrial fluid system is a poultry processing chiller system.

4. The system of claim 1, wherein the system component includes a chemical control system, and wherein the one or more remedial measures includes instructing the chemical control system to disperse a chemical.

5. The system of claim 1, wherein the one or more data collectors includes at least one of: a temperature sensor, a pH sensor, a peracetic acid sensor, or an imaging device.

6. The system of claim 1, wherein the one or more coded instructions include an artificial intelligence infrastructure, and wherein the at least one processing device is configured to analyze the at least one datum and determine the at least one potential problem using the artificial intelligence infrastructure.

7. The system of claim 1, wherein the one or more data collectors includes a first data collector local to the system component and a second data collector providing an external data feed via a server, and wherein the at least one processing device is configured to analyze the at least one datum by fusing data from the first data collector and the second data collector.

8. A system for automated microbial control in a poultry processing chiller, comprising:
a poultry processing chiller component configured to implement a chilling process;
a pH sensor and an imaging device communicatively coupled to the poultry processing chiller component, the pH sensor and imaging device configured to generate a pH datum and an imaging datum, respectively, associated with the chilling process;
at least one controller communicatively coupled to the pH sensor and the imaging device, the at least one controller including:
at least one storage medium;
at least one processing device; and
one or more coded instructions stored in the at least one storage medium, wherein the one or more coded instructions include a trained artificial intelligence model, and wherein the one or more coded instructions, when executed by the at least one processing device, cause the at least one processing device to:
receive the pH datum from the pH sensor and the imaging datum from the imaging device;
generate, using the trained artificial intelligence model, a predicted microbial load value by applying the pH datum and the imaging datum to the model;
compare the predicted microbial load value to a predetermined microbial safety threshold stored in the at least one storage medium; and
in response to the predicted microbial load value exceeding the predetermined microbial safety threshold, autonomously implement a remedial measure by causing an adjustment to a chemical control system, wherein the adjustment comprises instructing the chemical control system to dispense a peracetic acid solution into the poultry processing chiller component.

9. The system of claim 1, wherein the one or more coded instructions, when executed by the at least one processing device, further cause the at least one processing device to:
receive an external data feed via a server, the external data feed comprising environmental temperature data associated with the poultry processing chiller; and
wherein generating the predicted microbial load value is further based on applying the environmental temperature data to the trained artificial intelligence model.

10. The system of claim 1, wherein the trained artificial intelligence model is a convolutional neural network (CNN) trained on a reference dataset of chiller images and corresponding known microbial counts to identify visual patterns indicative of biofilm formation from the imaging datum.

11. The system of claim 1, wherein the one or more coded instructions, when executed by the at least one processing device, further cause the at least one processing device to: continue to instruct the chemical control system to dispense the peracetic acid solution until a subsequent pH datum received from the pH sensor indicates the predetermined microbial safety threshold is met.

12. A method for facilitating process improvement, the method including:
receiving, by at least one processing device, at least one datum from one or more data collectors, the one or more data collectors being communicatively coupled to a system component implementing at least one process;
analyzing, by the at least one processing device, the at least one datum;
determining, by the at least one processing device and based on the analysis, that the at least one datum indicates at least one potential problem associated with the at least one process;
identifying, by the at least one processing device and in response to the determination, one or more remedial measures to prevent the at least one potential problem; and
autonomously implementing, by the at least one processing device, the one or more remedial measures by causing an adjustment to the system component.

13. The method of claim 12, wherein the at least one process is part of an industrial fluid system.

14. The method of claim 13, wherein the industrial fluid system is a poultry processing chiller system.

15. The method of claim 12, wherein the system component includes a chemical control system, and wherein the step of autonomously implementing the one or more remedial measures includes instructing the chemical control system to disperse a chemical.

16. The method of claim 12, wherein the at least one datum is received from at least one of:
a temperature sensor, a pH sensor, a peracetic acid sensor, or an imaging device.

17. The method of claim 12, wherein the one or more coded instructions include an artificial intelligence infrastructure, and wherein the steps of analyzing the at least one datum and determining the at least one potential problem are performed using the artificial intelligence infrastructure.

18. The method of claim 12, wherein the step of receiving the at least one datum includes receiving a first datum from a first data collector local to the system component and receiving a second datum from a second data collector providing an external data feed, and wherein the step of analyzing includes fusing the first datum and the second datum.

19. The method of claim 12, wherein the step of analyzing the at least one datum includes comparing the at least one datum to one or more predefined setpoints or to previously-received historical data.

20. The method of claim 12, further including:
receiving, from a remote computing device via a network connection, a user-defined parameter; wherein the step of determining the at least one potential problem is based at least in part on the user-defined parameter.
